(19) United States
(12) Patent Application Publication
(10) Pub. No.: US 2015/0360959 A1
(43) Pub. Date: Dec. 17, 2015

(54) METHOD OF PRODUCING SILICON CARBIDE AND SILICON CARBIDE

(71) Applicants: SHIN-ETSU HANDOTAI CO., LTD., Chiyoda-ku, Tokyo (JP); SHIN-ETSU CHEMICAL CO., LTD., Chiyoda-ku, Tokyo (JP)

(72) Inventors: Ryoji HOSHI, Nishigo-mura (JP); Suguru MATSUMOTO, Nishigo-mura (JP); Yoshitaka AOKI, Takasaki (JP); Chinami MATSUI, Annaka (JP)

(73) Assignees: Shin-Etsu Handotai Co., Ltd., Chiyoda-ku, Tokyo (JP); SHIN-ETSU CHEMICAL CO., LTD., Chiyoda-ku, Tokyo (JP)

(21) Appl. No.: 14/763,966

(22) PCT Filed: Jan. 30, 2014
(86) PCT No.: PCT/JP2014/000469

§ 371 Date: Jul. 28, 2015

(30) Foreign Application Priority Data
Feb. 26, 2013 (JP) 2013-035713

(51) Int. Cl. C01B 31/36

(52) U.S. Cl. CPC C01B 31/36

(57) ABSTRACT

The present invention provides a method of producing silicon carbide, comprising: providing a silicon-crystal producing apparatus with a carbon heater; forming a silicon carbide by-product on a surface of the carbon heater when a silicon crystal is produced from a silicon melt contained in a container heated by the carbon heater under a non-oxidizing atmosphere; and collecting the silicon carbide by-product to produce the silicon carbide. A method that can produce silicon carbide with low energy at low cost is thereby provided.

### TECHNICAL FIELD

The present invention relates to a method of producing silicon carbide and the silicon carbide, and more particularly to silicon carbide used for various applications such as a raw material of a polishing, agent, a firing component, or a semiconductor silicon carbide single crystal, and a method of producing this silicon carbide.

### BACKGROUND ART

Silicon carbide (SiC) is used for a polishing agent because of a high degree of hardness, high heat resistance, and high abrasion resistance. Silicon, carbide is also used as substitute materials for metal etc., in energy or aerospace fields, such as bearings, mechanical seals, or components for use in semiconductor devices, because of a high degree of rigidity and a high thermal conductivity. Silicon carbide also has the properties of semiconductors, and its single crystal is used for power devices. Thus, silicon carbide is a material of interest.

There are three major methods of producing powdery or polycrystalline silicon carbide, which is a starting material.

The first is the Acheson method that applies electric current to and heats silica sand and coke disposed around a graphite electrode. The second is the vapor-phase growth method of synthesis by the reaction of a silane gas or a methane gas. The third is the SiO₂ reduction method that reduces silica (SiO₂) by carbon (C) at a high temperature.

Among these, the silicon carbide by the Acheson method has a problem of low purity. The vapor-phase growth method has a problem of low productivity. The reduction method causes nonuniformity of the Si-to-C ratio due to accuracy of the mixture ratio of silica and carbon. As disclosed in, for example, Patent Document 1, it is necessary to determine silica-to-carbon mole ratio and pay close attention to the bulk density of powdery raw material, the filling degree in a container, and so on. In particular, all the three methods need a high temperature treatment, which arises a cost problem for production.

Accordingly, in order to reduce the production cost of silicon carbide, the decrease in raw material cost is attempted by mixing carbon into waste silicon sludge and heating the resultant (Patent Document 2), emitting high frequency waves to carbide powder of silicon accumulation biomass (Patent Document 3), heating glass fiber reinforced plastic (Patent Document 4), or other methods.

There are also disclosed technics to produce silicon carbide with high efficiency and high productivity by heating graphite impregnated with silane or siloxane (Patent Document 5), or heating a curable silicone composite (Patent Document 6).

These technics however need exclusive energy to produce the silicon carbide.

### CITATION LIST

### Patent Literature

Patent Document 1:Japanese Unexamined Patent publication (Kokai) No. S58-20708
Patent Document 2:Japanese Unexamined Patent publication (Kokai) No. 2002-255532
Patent Document 3:Japanese Unexamined Patent publication (Kokai) No. 2003-176119
Patent Document 4:Japanese Unexamined Patent publication (Kokai) No. 2012-250863
Patent Document 5:Japanese Unexamined Patent publication (Kokai) No. 2002-274830
Patent Document 6:Japanese Unexamined Patent publication (Kokai) No. 2009-155185

### SUMMARY OF INVENTION

### Technical Problem

The present invention was accomplished in view of the above-described problems. It is an object of the present invention to provide a method that can produce silicon carbide with low energy at low cost.

### Solution to Problem

To achieve this object, the present invention provides a method of producing silicon carbide, comprising: providing a silicon-crystal producing apparatus with a carbon heater; forming a silicon carbide by-product on a surface of the carbon heater when a silicon crystal is produced from a silicon melt contained in a container heated by the carbon heater under a non-oxidizing atmosphere; and collecting the silicon carbide by-product to produce the silicon carbide.

Conventionally, the methods described previously are implemented to exclusively produce silicon carbide. The silicon carbide is thus produced by spending cost and energy.

The inventive producing method however can produce a silicon crystal and silicon carbide as a by-product of the production. In other words, not only the silicon crystal but also the silicon carbide can be produced with the cost and energy required for producing the silicon crystal. Basically, the cost and energy for producing the silicon carbide can therefore be made substantially zero. The silicon carbide can be produced with significantly lower cost and lower energy than the conventional methods.

The silicon carbide by-product can be formed also on a surface of another carbon component in the silicon-crystal producing apparatus and collected when the silicon crystal is produced.

In this manner, the silicon carbide can be produced with higher productivity.

The silicon crystal can be produced by a Czochralski method using a quartz crucible as the container to contain the silicon melt while an inert gas is introduced into the silicon-crystal producing apparatus.

Use of the quartz crucible results in introduction of oxygen into the silicon melt when the quartz crucible is dissolved, thereby causing an SiO gas to evaporate from the surface of the silicon melt. This facilitates the formation of silicon carbide by the reaction of SiO+2C→SiC+CO.

In general, since carbon components used for production of silicon crystals by the Czochralski (CZ) method are purified, for example, by a high temperature treatment, the carbon components have high purity. The formed silicon carbide can thereby have high purity.

Moreover, the silicon crystal can be produced while an inert gas is introduced into the silicon-crystal producing apparatus and the inert gas is guided to the carbon heater after the inert gas passes over a surface of the silicon melt.

In this manner, the inert gas that has passed over the surface of the silicon melt and thereby contains an SiO gas and other gases can be efficiently caused to flow to the carbon heater. The silicon carbide is thereby easy to form on the surface of the carbon heater.

Moreover, a pressure of a furnace in the silicon-crystal producing apparatus may range from 1 hPa to 500 hPa when the silicon crystal is produced.

In this manner, the evaporation of the SiO gas from the silicon melt and the formation of the silicon carbide can be facilitated.

Moreover, after a production batch process of the silicon crystal is finished, the silicon carbide by-product formed into a powder can be sucked and collected.

Moreover, after a production batch process of the silicon crystal is finished, or at an end of a lifetime of the carbon heater, the silicon carbide by-product formed into layers or a lump can be peeled and collected.

In these manner, the silicon carbide can be efficiently collected.

Moreover, the collected silicon carbide can be classified and pulverized.

In this manner, powdery silicon carbide having a desired properties, for example, depending on use can be obtained.

Moreover, silicon carbide produced by the inventive method, wherein a nitrogen content of the silicon carbide is 0.02 mass % or less can be provided.

The silicon carbide produced by the inventive method can have a significantly low nitrogen content of 0.02 mass % or less, and high purity.

### Advantageous Effects of Invention

As described above, the present invention can produce silicon carbide as a by-product of silicon crystal production without a separate operation for silicon carbide production, significantly reduce the cost and energy required for producing the silicon carbide, and obtain extremely high purity silicon carbide.

### BRIEF DESCRIPTION OF DRAWINGS

FIG. 1 is a flowchart of an example of the inventive method of producing silicon carbide;

FIG. 2 is a schematic diagram of an exemplary CZ single-crystal pulling apparatus that can be used in the inventive method of producing silicon carbide; and

FIG. 3 shows the result of measurement of a solid NMR of the collected silicon carbide in Example 2 and commercial silicon carbide.

### DESCRIPTION OF EMBODIMENTS

An embodiment of the present invention will be hereinafter described in detail with reference to the drawings, but the present invention is not limited to this embodiment.

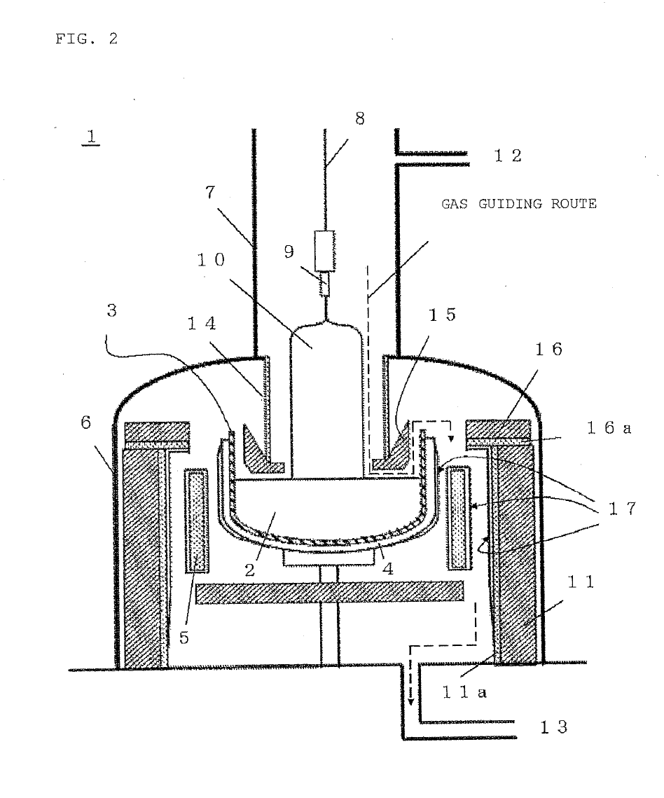

FIG. 2 shows an exemplary silicon-crystal producing apparatus that can be used in the inventive method of producing silicon carbide. A CZ single-crystal pulling apparatus is shown here by way of example, but this is of course not limitation. It suffices that a silicon single crystal can be produced, and a silicon carbide by-product can be formed on a surface of a carbon heater.

The CZ single-crystal pulling apparatus 1 shown in FIG. 2 is provided with a container (here, a crucible such as a quartz crucible 3 or a graphite crucible 4) to contain a silicon melt 2, a carbon heater 5 (a graphite heater) to heat and melt a polycrystalline silicon raw material, and other components, in a main chamber 6 that is cooled by water. In addition, a pulling mechanism (not shown) to pull a grown single crystal is provided at an upper part of a pulling chamber 7 continuously provided on the main chamber 6.

A wire 8 for pulling is reeled out from the pulling mechanism attached to the upper part of the pulling chamber 7. A seed crystal 9 supported with a seed holder is attached to one end of the wire. The seed crystal 9 is dipped into the silicon melt 2, and the wire 8 for pulling is wound with the pulling mechanism so that a silicon single crystal 10 can be formed below the seed crystal 9.

Note that the quartz crucible 3 and the graphite crucible 4 are supported by a crucible rotating shaft that can rotate and move upward and downward by a rotation drive mechanism (not shown) attached to a lower part of the CZ single-crystal pulling apparatus 1.

Moreover, slits are formed by turns from an upper part and a lower part of the carbon heater 5 disposed around the quartz crucible 3 and the graphite crucible 4 to form a route through which an electric current flows.

Moreover, a heat insulator (a heat shield 11) that is made of, for example, carbon fiber to inhibit a heat loss is provided outside the carbon heater 5. Moreover, the inside of the heat shield 11 is covered with a thin graphite material (an inner shield 11a) to prevent the deterioration of the heat shield 11.

Moreover, an upper shield insulator 16 whose inside is covered with an upper shield 16a is provided over the carbon heater 5 so as to protrude from the heat shield 11 and the inner shield 11a. These are made of a carbon material such as graphite.

Thus, other carbon components, such as the graphite crucible 4, the inner shield 11a, and the upper shield 16a, are disposed around the carbon heater 5. A silicon carbide by-product 17 is formed on the surface of these components when a silicon single crystal is produced.

Moreover, the chambers 6 and 7 are provided with a gas inlet 12 and a gas outlet 13. An inert gas such as an argon gas can be introduced in the interior of the chambers 6 and 7 and forcibly discharged with an additional vacuum pump, or the like. The interior of the main chamber 6 of the CZ single-crystal pulling apparatus 1 can thereby be filled with the inert gas and controlled to be, for example, under a reduced pressure when the silicon single crystal 10 is produced.

A gas-flow guiding cylinder 14 extends from at least a ceiling of the main chamber 6 toward the surface of the silicon melt so as to surround the silicon single crystal 10 during pulling. Moreover, a heat shield 15 is provided to shield radiant heat from the carbon heater 5 at between the vicinity of the silicon melt surface and the gas-flow guiding cylinder 14, so that the silicon single crystal 10 is cooled.

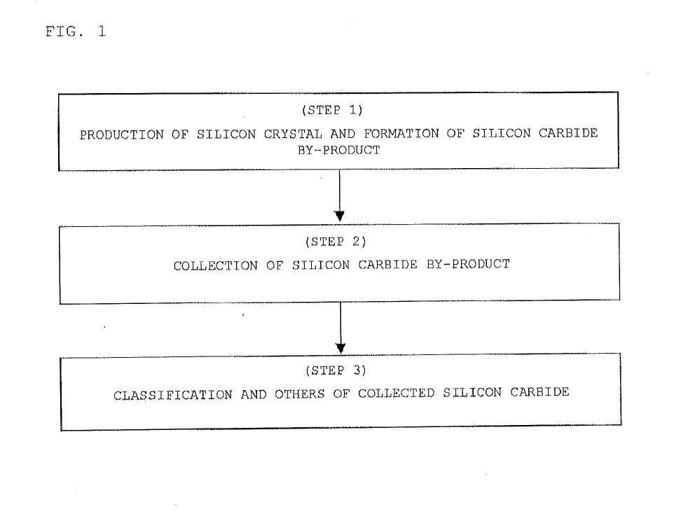

The inventive method of producing silicon carbide will next be described in detail. FIG. 1 shows an example of the flow in the inventive producing method.

(Step 1: Production of a Silicon Crystal and Formation of a Silicon Carbide by-Product)

A silicon crystal (here, a silicon single crystal) is first produced from the silicon melt under a non-oxidizing atmosphere with a silicon-crystal producing apparatus provided with a carbon heater in the inside. The type of this silicon-crystal producing apparatus is not particularly limited, as described previously. Here the production by using the CZ single-crystal pulling apparatus 1 including the quartz crucible as shown in FIG. 2 will be described.

In particular, the reason why use of this CZ single-crystal pulling apparatus 1 is preferable will be now described.

The reaction that produces silicon carbide in a main chamber of a producing apparatus for growing a silicon crystal is thought to be as follows: Si+C→SiC; SiO₂+3C→SiC+2CO; or SiO+2C→SiC+CO. The maximum of ambient temperature in the furnace, under which a silicon single crystal is grown, is about 2000° C. because the melting point of silicon is 1412° C. Under such a temperature range, the reaction of SiO+2C→SiC+CO among the above reactions is easiest to occur. In addition, when the quartz crucible is used to contain the silicon melt, the quartz crucible is melted to introduce oxygen into the silicon melt, and an SiO gas is evaporated from the surface of the silicon melt. The formation of silicon carbide due to SiO+2C→SiC+CO is thereby easy to proceed.

In general, since the carbon components used for production of silicon single crystals by the CZ method are purified, for example, by a high temperature treatment, these carbon components have high purity. In addition, the quartz crucible is highly purified by using synthetic quartz for its inner surface. The silicon carbide by-product formed in production of a silicon single crystal by the CZ method therefore has the advantage of very high purity.

In the production of a silicon single crystal, a polycrystalline raw material is first introduced into the crucible (outside graphite crucible 4, and inside quartz crucible 3), and heated and melted by the carbon heater 5 surrounded by the inner shield 11a and the upper shield 16a so that the silicon melt 2 is obtained. Then, the seed crystal 9 is dipped into the silicon melt 2 and pulled to produce the silicon single crystal 10 by the CZ method.

During the production of the silicon single crystal, the above reaction occurs on the surface of the carbon heater 5, and the silicon carbide 17 can thereby be formed as a by-product. In this way, the silicon carbide 17 can be formed as the by-product on the surface of the carbon heater 5 that has the highest temperature in the main chamber 6. Otherwise, as shown in FIG. 2, other carbon components, such as the graphite crucible 4, the inner shield 11a, and the upper shield 16a, can be disposed at the vicinity of the carbon heater 5 to form the silicon carbide 17 as the by-product also on the surface of these components. This way is preferable because the silicon carbide 17 as the by-product can be obtained in larger amounts and the productivity can be improved.

The production conditions (the configuration and the pressure of the furnace, and so on) of the silicon single crystal under which these silicon carbide by-products are easier to form will be described below by way of example.

First, it is preferable to define a gas guiding route so as to cause an inert gas, such as argon (Ar), to flow in the main chamber, to pass over the surface of the silicon melt, and to direct the gas toward the carbon heater. As shown in FIG. 2, providing the gas inlet 12 in the pulling chamber, and the gas outlet 13 in the lower part of the main chamber, the gas-flow guiding cylinder 14, the heat shield 15, the inner shield 11a, and the upper shield 16a allows the inert gas introduced from the gas inlet 12 to flow near the surface of the silicon melt 2 and to be guided to the carbon heater 5. The gas can be then discharged from the main chamber 6.

In this way, the SiO gas generated from the surface of the silicon melt can efficiently be carried to the carbon heater, thereby facilitating the reaction of SiO+2C→SiC+CO on the surface of the carbon heater.

Secondary, it is preferable to forcibly discharge the inert gas from the gas outlet by using, for example, a vacuum pump. This configuration enables the gas passing over the silicon melt to efficiently flow to the carbon heater, thereby making it easy to form the silicon carbide on the surface of the carbon heater.

Finally, maintaining a reduced pressure further promotes the evaporation of SiO, thereby facilitating the formation of the silicon carbide by the reaction of SiO+2C→SiC+CO. In this case, when the pressure is 500 hPa or less in particular, the amount of the evaporation of SiO can be efficiently increased; when the pressure is 1 hPa or more, excessively rapid elution of the quartz crucible due to high vacuum can be prevented.

(Step 2: Collection of the Silicon Carbide by-Product)

The silicon carbide is formed on the surface of the carbon heater and the carbon components at its vicinity in the above manner, and collected after a production batch process of the silicon single crystal is finished. If powdery silicon carbide is formed, then it can be collected by suction.

In the production of the silicon single crystal, the silicon carbide is formed in the largest amount on the surface of the carbon heater, which has the highest temperature in the furnace (the main chamber), as described above. On the surfaces of the carbon heater and the other carbon components at its vicinity, such as the graphite crucible, powdery silicon carbide, for example, is formed. This powdery silicon carbide is efficiently collected by suction of, for example, a vacuum cleaner.

When the silicon carbide, meanwhile, is formed into layers or a lump particularly on the surface of the carbon heater, the silicon carbide may be peeled from the carbon heater to collect the silicon carbide after a production batch process of the silicon single crystal is finished, or at the end of the lifetime of the carbon heater.

Since the reaction of silicon carbide proceeds most on the surface of the carbon heater, which has the highest temperature in the furnace, the silicon carbide particularly tends to be formed in a lump. Since the silicon carbide lump is difficult to collect by suction, it is efficient to peel the lump from the carbon heater to collect the silicon carbide. The operation of peeling the silicon carbide from the carbon heater may be performed every time when the production batch process of the silicon single crystal is finished, or collectively after the lump grows to a certain extent.

The surface of the carbon heater rapidly changes into the silicon carbide, and the thickness of a carbon portion of the carbon heater on which the slits are formed rapidly decreases. Therefore, the performance of the heater will be finally lost. The silicon carbide may be collectively peeled at the end of the heater lifetime.

Note that the silicon carbide lump may be peeled with a scraper or by hitting the lump with a hammer. The optimum material, such as metal or ceramics, may be used for these tools.

### (Step 3: Classification and Others of the Collected Silicon Carbide)

The silicon carbide that has been formed and collected in the above manner is classified and pulverized so that powdery silicon carbide having a desired characteristics can be obtained. The procedures of the classification and the pulverization can be determined properly depending on the use of the silicon carbide, and so on.

The components in the furnace is commonly made of carbon, silicon, and quartz. The collected silicon carbide, when being formed, for example, in the CZ single-crystal pulling apparatus, consists of elements of C, Si, and O. Silicon raw materials naturally has high purity at a semiconductor grade. The quartz crucible usually uses synthetic quartz having high purity for its inner surface, which is to contact the silicon melt, and thus maintains high purity. The carbon components, which are usually used in the furnace, are purified by a high temperature treatment and thereby has high purity. Since there is only an inert gas in the furnace other than these, the concentration of other impurities is extremely low.

Conventionally, a common method using pitch-based carbon derived from plants or raw material derived from phenol resin in production of silicon carbide is particularly hard to remove nitrogen. The present invention can hold nitrogen at a very low concentration and, for example, keep the nitrogen content equal to or less than 0.02 mass %.

The silicon carbide obtained here has mainly the 3C type (β type) of crystal system because the silicon carbide is produced by being reacted at a comparatively low temperature. In addition, since only high purity raw materials can be used as above, and the growth can take a lot of time without forcible reaction, high quality silicon carbide having high purity and an Si-to-C ratio of about 1:1 can be obtained. Pieces having a desired size obtained by pulverizing these can be used as an ultrahigh grade such as raw material for use in production of silicon carbide semiconductor single crystal or seed crystals, not to mention polishing agents.

The inventive method of producing silicon carbide, as described above, can produce silicon carbide as a by-product of production of a silicon single crystal instead of producing the silicon carbide alone. As a whole, the cost and energy of silicon carbide production can be significantly reduced.

### EXAMPLE

The present invention will be more specifically described with reference to examples and a comparative example, but the present invention is not limited to these examples.

### Example 1

The inventive method of producing silicon carbide shown in FIG. 1 was implemented. A silicon single crystal was grown with the CZ single-crystal pulling apparatus 1 shown in FIG. 2.

Note that a graphite heater having an outer diameter of 800 mm was used as the carbon heater. A heat insulator (a heat shield) made of carbon fiber was disposed to inhibit a heat loss inside the main chamber that was forcibly cooled. The inside of this heat insulator was covered with a thin graphite material (an inner shield) to prevent the deterioration of the heat insulator. An upper shield insulator and an upper shield formed of a graphite material on the surface thereof were disposed over the graphite heater so as to protrude from the heat shield and the inner shield.

A used container to contain the silicon melt was a crucible constituted of an outside graphite crucible (having an inner diameter of about 660 mm) and an inside quartz crucible in which synthetic quartz was formed inside natural quartz.

Moreover, when the silicon single crystal was pulled, an argon gas as an inert gas was caused to flow from the gas inlet. The flow rate was in the range from 50 to 200 L/min. This inert gas passed between the gas-flow guiding cylinder and the silicon single crystal and was guided to above the surface of the silicon melt. The inert gas flowed through the gas guiding route defined by the heat shield disposed right above the silicon melt and the silicon melt surface, and was discharged to the exterior of the crucible through a guide path defined by the inner wall of the crucible and the outside of the heat shield. The inert gas was then guided to the graphite heater, and forcibly discharged from the gas outlet located at the lower part of the main chamber by a vacuum pump. At this time, the discharge capacity of the vacuum pump was adjusted such that the pressure of the interior of the furnace ranged from 50 to 300 hPa.

A gas containing SiO that was discharged from the crucible accordingly flowed toward the gas outlet through the gas guiding route defined by the outer wall of the graphite crucible, the lower part of the upper shield, and the inner wall of the inner shield. Since there was the graphite heater on this gas guiding route formed by the graphite crucible, the upper shield, and the inner shield, the reaction of producing silicon carbide occurred thereat. Although this silicon carbide producing reaction proceeds most at the heater, which had the highest temperature, the silicon carbide producing reaction occurred also at the outer wall of the graphite crucible, the lower part of the upper shield, and the inner wall of the inner shield, which were disposed at its vicinity.

A silicon single crystal having a diameter of about 200 mm was grown under the above conditions. One batch process grew one silicon single crystal or plural silicon single crystals.

When the silicon single crystal was produced, silicon carbide by-products were formed on the surface of the graphite components, such as the graphite heater, the graphite crucible, the inner shield, and the upper shield.

These silicon carbide by-products were collected with a vacuum cleaner at every end of the batch process, so the silicon carbide was obtained.

Since the silicon carbide was produced together with the production of the silicon single crystal, the cost and energy were reduced.

The silicon carbide obtained by the present invention was then analyzed.

First, the microscopic Raman analysis of the collected silicon carbide powder was conducted. A sharp peak was consequently seen at 795 cm⁻¹. The obtained powder was very beautiful yellow. Thus, the 3C type (β type) of silicon carbide having very high purity was obtained.

Next, oxygen analysis was conducted with an oxygen analyzing apparatus (made by LECO Corporation, Brand name:TC436). The oxygen content was 0.1 mass % or less. The nitrogen content was 0.00 mass %. It can be seen from the fact that the nitrogen content of silicon carbide produced with phenol resin like the conventional way is about 0.2 mass % that the nitrogen content of the silicon carbide by the invention was very low. The Si-to-C element ratio was 1:1.00, which indicates very good crystallinity.

### Example 2

The same production batch as example 1 was repeated. The process of producing silicon carbide on the graphite heater thereby proceeded, and the thickness of the graphite portion forming the slits was rapidly decreased. Lumps of the silicon carbide were formed until the performance of the graphite heater was lost.

The silicon carbide accumulated on the graphite heater whose performance was lost was peeled from the graphite heater and collected. The collected silicon carbide crystal that was yellow green weighed about 3.1 kg.

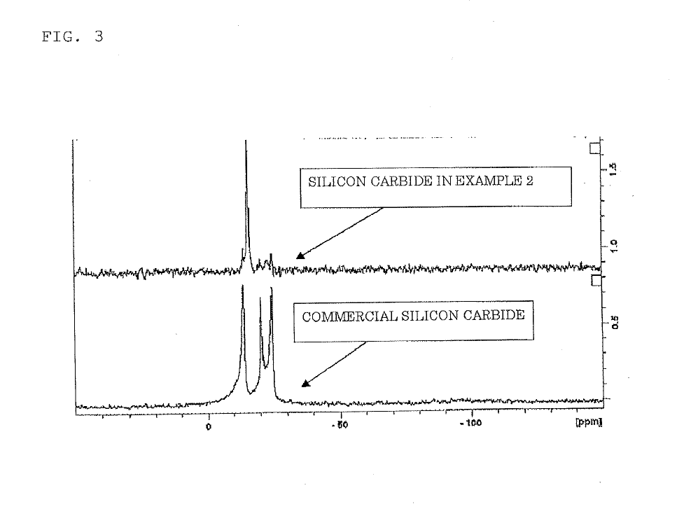

In addition, the obtained yellow green silicon carbide was partially scraped off and the resultant portion was analyzed by the X-ray diffraction and the solid NMR. The result was that the crystal system was 3C type (β type). FIG. 3 shows a peak by the solid NMR. Note that commercial silicon carbide powder by the conventional method was also analyzed by the solid NMR for comparison. This result is also shown in FIG. 3. The horizontal axis in FIG. 3 shows “chemical shift”, which is an indicator representing the status of the 13C nucleus; the vertical axis shows a signal strength according to the amount of 13C in each status. In example 2, the status of the 13C nucleus was nearly single, and the signal strength was thereby detected in larger amounts than the commercial one.

As seen in FIG. 3, the silicon carbide by the invention has a sharper peak and better crystallinity than the commercial silicon carbide powder that has mixed crystal system such as 6H type.

The oxygen analysis was conducted with the oxygen analyzing apparatus (made by LECO Corporation, Brand name:TC436). The oxygen content was 0.2 mass % or less. The nitrogen content was 0.01 mass %. The Si-to-C element ratio was 1:0.99, which indicates very good crystallinity.

In addition, the ICP emission spectrometry was conducted. The result of the content of various elements shown in Table 1 was consequently obtained. As shown in Table 1, it is seen that Ca was 0.1 ppm; others such as Fe were less than 0.1 ppm; the proportion of impurities was very small; and silicon carbide having very high purity was obtained.

TABLE 1

| ANALYZED | |
|---|---|
| ELEMENT | MEASURED VALUE (ppm) |
| Fe | <0.1 |
| Cr | <0.1 |
| Ni | <0.1 |
| Al | <0.1 |
| Ti | <0.1 |
| Cu | <0.1 |
| Na | <0.1 |
| Zn | <0.1 |
| Ca | 0.1 |
| Zr | <0.1 |
| Mg | <0.1 |
| B | <0.1 |

Furthermore, an attempt to use the silicon carbide powder produced in examples 1 and 2 was made.

First, 100 mass parts of the obtained silicon carbide powder and 3 mass parts of methyl cellulose (Brand name: metolose, made by Shin-Etsu Chemical Co., Ltd) as an organic binder were put into a container of a planetary ball mill of the P-4 type (registered trademark) (a pulverizing mixer made by Fritsch Japan Co., Ltd), and blended at room temperature for one hour. The obtained mixed powder was added to 20 mass parts of wafer, and the resultant mixture was introduced into Planetary Mixer (registered trademark) (a mixer made by INOUE MFG., INC) and stirred at room temperature for one hour to obtain a body. The body was then heated at 105° C. for five hours to evaporate water, so that powdery raw material composite was obtained.

This raw material composite was put into a mold and pressed under a pressure of 100 kgf/cm² for five minutes so that a cylindrically molded body having a diameter of 110 mm and a thickness of 82 mm was obtained. This molded body was put into a rubber mold and pressed under a pressure of 2000 kgf/cm² for one hour by a CIP molding machine of Dr.CIP (registered trademark) (made by Kobe Steel Ltd). The dimension after the CIP molding was a diameter of 108 mm×a thickness of 80 mm.

The molded body thus obtained was heated to 1000° C. under a nitrogen gas atmosphere and cooled. A black inorganic molded body substantially consisting of carbon, silicon, and oxygen was consequently obtained. The dimension of this inorganic molded body was a diameter of 108 mm×a thickness of 80 mm. Its shape was substantially the same as the shape before the heat treatment.

This inorganic molded body was then heated to 2000° C. under an argon gas atmosphere. After being heated at 2000° C., the inorganic molded body was cooled. A green molded body of silicon carbide was consequently obtained. The dimension of this molded body of silicon carbide was a diameter of 108 mm×a thickness of 80 mm. Its shape was substantially the same as the above inorganic molded body.

This molded body of silicon carbide was used as a raw material for use in growth of silicon carbide by using the sublimation method. A single crystal was consequently produced.

In contrast to the exemplary use of the silicon carbide powder obtained by the present invention, a raw material composite was prepared in the same manner as above except for using commercial silicon carbide powder (Brand name:SHINANO-RUNDUM, made by Shinano Electric Refining Co., Ltd) instead, and subjected to press molding. After the CIP molding, a degrease process and a firing process were performed. It was in a powdery state and its shape was not held.

### Comparative Example

Silicon carbide was produced by the conventional method disclosed in Patent Document 5.

A mixture of tetramethyl tetravinyl cycrotetra siloxane (LS-8670 made by Shin-Etsu Chemical Co., Ltd), methyl hydrogen siloxane (KF-99 made by Shin-Etsu Chemical Co., Ltd), and a catalyst of chloroplatinic acid (1% chloroplatinic acid solution) were dissolved in toluene. Expanded graphite was added into this solution. The resultant was dried at 100° C. for about 30 minutes in a vacuum oven, and hardened under heating at 300° C. for one hour in the atmosphere. The resultant was heated to 1600° C. at a heating rate of about 300 K/hour in a stream of argon, left for one hour, and then cooled at a rate of about 200 K/hour. A grey product was consequently obtained.

The conventional method thus needs an exclusive process for silicon carbide production and therefore a higher cost and energy than the present invention.

The 3C type (β type) of silicon carbide having high purity is originally yellow. The fact that the silicon carbide obtained in the comparative example is grey suggests that oxygen remains. It is accordingly obvious that the silicon carbide obtained by the present invention as shown in examples 1 and 2 has superior quality.

It is to be noted that the present invention is not limited to the foregoing embodiment. The embodiment is just an exemplification, and any examples that have substantially the same feature and demonstrate the same functions and effects as those in the technical concept described in claims of the present invention are included in the technical scope of the present invention.

In particular, although a case of silicon single crystal growth was described in the embodiment and the examples, the present invention is not limited to single crystal production. When a polycrystal for use in a solar cell etc., is grown with a similarly configured apparatus, the same silicon carbide as the silicon single crystal growth can be produced. This case is included in the technical scope of the present invention.

1-9. (canceled)

10. A method of producing silicon carbide, comprising:
providing a silicon-crystal producing apparatus with a carbon heater;
forming a silicon carbide by-product on a surface of the carbon heater when a silicon crystal is produced from a silicon melt contained in a container heated by the carbon heater under a non-oxidizing atmosphere; and
collecting the silicon carbide by-product to produce the silicon carbide.

11. The method according to claim 10, wherein the silicon carbide by-product is formed also on a surface of another carbon component in the silicon-crystal producing apparatus and collected when the silicon crystal is produced.

12. The method according to claim 10, wherein the silicon crystal is produced by a Czochralski method using a quartz crucible as the container to contain the silicon melt while an inert gas is introduced into the silicon-crystal producing apparatus.

13. The method according to claim 11, wherein the silicon crystal is produced by a Czochralski method using a quartz crucible as the container to contain the silicon melt while an inert gas is introduced into the silicon-crystal producing apparatus.

14. The method according to claim 10, wherein the silicon crystal is produced while an inert gas is introduced into the silicon-crystal producing apparatus and the inert gas is guided to the carbon heater after the inert gas passes over a surface of the silicon melt.

15. The method according to claim 11, wherein the silicon crystal is produced while an inert gas is introduced into the silicon-crystal producing apparatus and the inert gas is guided to the carbon heater after the inert gas passes over a surface of the silicon melt.

16. The method according to claim 12, wherein the silicon crystal is produced while an inert gas is introduced into the silicon-crystal producing apparatus and the inert gas is guided to the carbon heater after the inert gas passes over a surface of the silicon melt.

17. The method according to claim 13, wherein the silicon crystal is produced while an inert gas is introduced into the silicon-crystal producing apparatus and the inert gas is guided to the carbon heater after the inert gas passes over a surface of the silicon melt.

18. The method according to claim 10, wherein a pressure of a furnace in the silicon-crystal producing apparatus ranges from 1 hPa to 500 hPa when the silicon crystal is produced.

19. The method according to claim 17, wherein a pressure of a furnace in the silicon-crystal producing apparatus ranges from 1 hPa to 500 hPa when the silicon crystal is produced.

20. The method according to claim 10, wherein after a production batch process of the silicon crystal is finished, the silicon carbide by-product formed into a powder is sucked and collected.

21. The method according to claim 19, wherein after a production batch process of the silicon crystal is finished, the silicon carbide by-product formed into a powder is sucked and collected.

22. The method according to claim 10, wherein after a production batch process of the silicon crystal is finished, or at an end of a lifetime of the carbon heater, the silicon carbide by-product formed into layers or a lump is peeled and collected.

23. The method according to claim 21, wherein after a production batch process of the silicon crystal is finished, or at an end of a lifetime of the carbon heater, the silicon carbide by-product formed into layers or a lump is peeled and collected.

24. The method according to claim 10, wherein the collected silicon carbide is classified and pulverized.

25. The method according to claim 23, wherein the collected silicon carbide is classified and pulverized.

26. Silicon carbide produced by the method according to claim 10, wherein a nitrogen content of the silicon carbide is 0.02 mass % or less.

27. Silicon carbide produced by the method according to claim 25, wherein a nitrogen content of the silicon carbide is 0.02 mass % or less.
